(19) United States
(12) Patent Application Publication
(10) Pub. No.: US 2005/0273758 A1
(43) Pub. Date: Dec. 8, 2005

(54) System and method for building a component base architecture

(76) Inventor: Michael V. Long, Frederick, MD (US)

Correspondence Address: H JAY SPIEGEL, P.O. BOX 444, MOUNT VERNON, VA, 22121, US

(21) Appl. No.: 10/523,674

(22) PCT Filed: Sep. 4, 2003
(86) PCT No.: PCT/US03/27447

§ 371 Date: Feb. 2, 2005

(30) Foreign Application Priority Data
Mar. 5, 2003 (US) 60451689
Mar. 14, 2003 (US) 60454328

(51) Int. Cl. G06F 9/44

(52) U.S. Cl. 717/101; 717/174; 717/115

(57) ABSTRACT

A system and method for building a component-based architecture. One or more software components (1401) are registered with a component-based architecture development environment (200) in accordance with an interface definition file (1406). The interface definition file (1406) identifies one or more methods invocable by the associated component's encapsulated code. The development environment (200) enables a user to select the one or more methods for defining component-to-component relationships in a script configured in a hierarchal tree format.

### FIELD OF THE INVENTION

This invention generally relates to the field of software development tools, and more specifically to development tools using component-oriented programming constructs.

### BACKGROUND OF THE INVENTION

While there are innumerable programming environments at the disposal of a computer programmer, the general evolution of programming environments has been relatively disjointed. Over time, a large variety of programming languages have been developed and employed for different tasks. For example, as a non-exhaustive list, the C programming language family, including C, C+, C++, and C#, primarily have been used to author desktop, server, or distributed computer applications, as has BASIC, PASCAL, ADA, TCK/TL, CORBA, and JAVA. For general use in network applications, computer programming languages such as the script languages, including JAVASCRIPT, VBSCRIPT, ASP, and PHP are most appropriate. For interaction with databases and repositories, SQL is the defacto programming standard. More recently, XML has emerged as a standard for sharing data between devices and applications.

Initially, each programming language had its respective Integrated Development Environments (IDEs), with their respective compilers (if it was a compilable language). However, applications that function in different areas of computer technology require a multitude of different tools and interfaces in order to work together. For example, to tie a website to a database, a programmer would use a first web development tool to make the graphics and navigation structure of the website and a second database tool to create the data repository. Unwanted temporal and financial costs can be attributed to the excessive time to learn these individual tools and become skilled in their operation.

Information within an organization is constantly being organized, stored, transferred and displayed. Within the organization, information technology functions or “zones” needed to handle such information frequently overlap and interact. Web services, such as eCommerce, Internet portals, applets and servlets organize information. Database systems, including SQL, Oracle, Sybase and other legacy systems store data. Browsers and applications on the desktop display information. Network applications are used to implement LANs, email systems and other communications systems. These information technology functions or zones need to interact with one another, however each uses its own separate software.

The software used by these information technology zones all has different interfaces and standards. It is difficult and expensive for an enterprise to locate and retain the necessary expertise in each of the different technology fields.

As software applications began to require a greater interdependence among a variety of computer languages, IDE's were developed that support a multitude of languages and technology zones. Such IDEs could be used to write desktop applications, server applications, web pages, database applications, etc. These IDE's comprised a compiler for each compilable programming language it supported, and it became easier for computer programmers to integrate different computer programming languages.

Yet many of these tools still require a programmer or team of programmers to learn multiple languages. Throughout the evolution of programming, languages were developed to overcome previous shortcomings. Consequently, programming languages today are inherently different from one another. Not only do languages have different programmatic syntaxes, but also their underlying fundamentals are often dissimilar. The more languages that a programmer must learn, the more unwanted financial and temporal costs can be attributed with creating software programs. Long and complex development cycles are required to develop the software, resulting in greatly increased cost for investing in information technology.

Another problem associated with existing development environments is the lack of code reuse. Advantages to code reuse include faster development times, lower development costs, and fewer errors in program code. A significant step in promoting code reuse was the introduction of Object-oriented programming (OOP) languages such as C++ and JAVA. OOP allows programming at increasingly higher levels of abstraction—from the object to the class to the class library and ultimately to the entire application framework.

There are three basic techniques that OOP languages use to promote code reuse: inheritance, encapsulation, and polymorphism.

Inheritance is the technique in which one class inherits the structure of data and functionality of a superclass. This allows the programmer to create new classes by using the member data and functions from an existing class and adding or modifying existing functionality, thereby promoting code reuse.

Encapsulation is the technique of separating the internal operations and data structure of an object from the interface that is exposed to the rest of the program. As software becomes complex, encapsulation is important in maintaining the software as well as extending its functionality.

Polymorphism is the technique of having objects behave differently based on the parameters passed to them. Polymorphism allows a programmer to use objects as specialized instances of their more generic types.

Progress in OOP has also left it with certain drawbacks. Objects in OOP are confined to a single program, and its reuse is not supported outside of the compiler that created the object. There is no way of accessing these objects for multiple programs. To overcome this drawback, distributed objects were developed.

Unlike traditional objects, distributed objects, also known as software components, are pieces of software that can be accessed by different networks, operating systems, and tool palettes. A component is not bound to a particular program, computer language, or implementation. ACTIVEX by MICROSOFT, and JAVABEANS by SUN MICROSYSTEMS are the competing component standards for the desktop. These components are toolable, meaning they can be imported within a standard IDE where it can be reused and also customized. COM+ by MICROSOFT, ENTERPRISE JAVABEANS (EJBs) by SUN MICROSYSTEMS, and CORBA BEANS by OBJECT MANAGEMENT GROUP are the competing component standards for the server.

Some visual programming IDE's such as MICROSOFT'S VISUAL STUDIO, IBM'S VISUAL AGE, or SUN MICROSYSTEMS' ONE STUDIO support toolable components, particularly ACTIVEX and JAVABEANS. Using “drag & drop” methods and some automatic code generation, components can be incorporated into custom programs. However, these environments still require extensive programming, and all require a knowledge of programming to operate. Unwanted temporal and financial costs persist even with the benefits of visual programming IDEs.

Some attempts have been made to create a complete Component-Oriented Programming (COP) environment. However, these COP environments have many drawbacks.

U.S. Pat. No. 6,044,218, Faustini, discloses a system for a live applet or application development visual programming environment that incorporates components for socialization therein. However, there are several drawbacks of this system.

Firstly, the system limits a programmer to designing only applets or application programs because deployment is dependent on the development environment. Other types of programs, such as servlets, portlets, HTML or XML file creation scripts, UNIX or PERL scripts, or other software components cannot be designed with the system of the '218 patent.

Secondly, the system of the '218 patent does not use an intuitive and efficient user interface. For example, looking at FIG. 16 of the '218 disclosure, a very simple applet is created using components, yet it is very difficult to decipher the operations of each component. The “wire” connectors between components are already difficult to trace. Furthermore, if a component has several dozen or more “connectors”, it becomes very difficult to display these connectors in conjunction with the component icon.

Thirdly, the development environment is inefficient and overly complex. The system of the '218 patent has a “what-you-see-is-what-you-get” (WYSIWYG) GUI builder which displays the physical view of the GUI. While components are displayed in both the physical view window and the logical view window, there is no relationship between each that is displayed to the user. This separation of the physical and logical views is a drawback.

U.S. Patent Application Publication No. 2002/0053070 A1 discloses a method of developing an application that is capable of flexibly coping with a variation in system environment, such as a system platform, for development of a component-based application. However, this method is overly complex since it includes both a physical component description and a logical component description.

U.S. Patent Application Publication No. 2002/0104073 A1 discloses a COP language which enables the definition of a multi-component structure of a system. Still, there are several drawbacks with such a definition.

Firstly, the COP language is limited to describing the JAVA BEAN architecture. That is, only components compatible with the JAVA BEAN component specification may be described using this COP-defined language. Such a limitation disregards a significant design feature of component programming, which is the use of components without consideration for its encapsulated code. Components scalable to the enterprise which support multiple sessions, such as ENTERPRISE JAVABEANS (EJB), are not supported by this COP language.

Secondly, the COP language does not support event-binding between components of multiple languages. The COP language describes the exact interconnections between a JAVABEAN and its methods to call other JAVABEANS. The COP language does not sufficiently abstract the interconnections made by the underlying components. Consequently, it becomes very difficult or virtually impossible for a development environment to identify components having compatible interfaces, which is further made problematic when working with components programmed in multiple languages. Such a drawback would place additional unwanted and costly demands on the user or programmer to have prerequisite knowledge of the components.

Thirdly, because an uncompilable markup language defines the COP language, a program cannot flexibly be deployed to a native language or environment, or multiple languages and multiple environments, which provides obvious advantages. That is, the COP language does not provide any type of compilation or deployment instructions.

From the foregoing, it should be apparent there is a deficiency in the prior art and a need for a simple and efficient way to share software components between users.

### SUMMARY OF THE INVENTION

The present invention overcomes the deficiencies of the prior art by providing a component-based architecture development environment. The invention provides the ability to develop entire software programs within a single, seamless programming environment using a set of components that encapsulate the functionality of databases, web servers, application servers, GUI development tools, parsing tools, math tools, graphics tools, and any variety of other functionality. Further, the invention may be used to rapid prototype software programs for feasibility analysis.

In one embodiment of the invention, a refined 3D graphical interface allows users to build and test scripts on the fly without keying in lines of program code.

The development environment provides for operatively connecting a plurality of components for building a component-based script. The script can be deployed to a component-based architecture.

The development environment makes use of an extended component architecture. It builds upon industry standards for component creation allowing integration of customized or third party components. Therefore new components can be added or existing components updated to increase the software's functionality.

One feature of the present invention is the novelty of the component framework. A component framework comprises a component wrapper to abstract the interconnections made by the underlying component binaries. This abstraction is advantageously exploited by the development environment to provide more direct control over component interactions and relationships. In this manner, the development environment can employ such novel features as automatically identifying components having compatible interfaces, which relieves the user of the development environment from the burden of having previous knowledge of programming and knowledge of the components. The abstraction allows a user to manipulate component interactions even while a script is running. The component wrappers are still further abstracted to an interface description file which describes the interface of the component wrapper.

The present invention can be used to develop component-based scripts and architectures in any of the information technology zones, greatly reducing the cost and amount of time needed to develop a program. Still, it would be advantageous to be able to share logic components between different development zones to quickly and efficiently develop architectures for multiple environments.

In one embodiment of the present invention, a “logic hub” or “peer network” is provided for integrating information technology zones through the sharing of software components. Components can be exchanged over a network, such as a local network or global network like the Internet. The interface description file provides a description standard for sharing components over the network.

In still yet another embodiment, a peer group can collaboratively work on a script from one or more workstations networked to a central server.

### BRIEF DESCRIPTION OF THE DRAWINGS

The following detailed description, given by way of example and not intended to limit the present invention thereto, will best be appreciated in conjunction with the accompanying drawings, wherein like reference numerals denote like elements and parts, in which:

FIG. 1 shows a block diagram of a computer system in accordance with one embodiment of the invention;

FIG. 2 shows a block diagram of a component-based architecture development environment in accordance with one embodiment of the invention;

FIG. 3 shows an example of a display interface in accordance with one embodiment of the invention;

FIG. 4 shows an example of the interacts window of the display interface in accordance with one embodiment of the invention;

FIG. 5 shows an example of a display interface with an “Environment” node selected in accordance with one embodiment of the invention;

FIG. 6 shows an example of a display interface with a “Program Type” method selected in accordance with one embodiment of the invention;

FIG. 7 shows an example of a display interface with an “Application” node selected in accordance with one embodiment of the invention;

FIG. 8 shows an example of a display interface with an “On Start” method selected in accordance with one embodiment of the invention;

FIG. 9 shows an example of a display interface with a “Window” node selected in accordance with one embodiment of the invention;

FIG. 10 shows an example of a display interface showing a component script in accordance with one embodiment of the invention;

FIG. 11A-B shows the script of FIG. 10 running in the development environment in accordance with one embodiment of the invention;

FIG. 12A-B shows an example of a display interface showing hide and reveal states of a component script in accordance with one embodiment of the invention;

FIG. 13A-C shows an example of a display interface showing expanded, collapsed, and intermediary states of a component script in accordance with one embodiment of the invention;

FIG. 14 shows a block diagram of a component framework in accordance with one embodiment of the invention;

FIG. 15 shows an example of a component description file in accordance with one embodiment of the invention;

FIG. 16 shows an example of a script file in accordance with one embodiment of the invention;

FIG. 17 shows a flow chart for an initialization process in accordance with one embodiment of the invention;

FIG. 18 shows a flow chart for a script loading process in accordance with one embodiment of the invention;

FIG. 19 shows a flow chart for a run process for running a script in accordance with one embodiment of the invention; and,

FIG. 20 shows a flow chart for a deployment process in accordance with one embodiment of the invention.

### DETAILED DESCRIPTION OF THE INVENTION

In the following detailed description of one embodiment of the invention, reference is made to the accompanying drawings, which form a part hereof, and in which is shown by way of illustration of a specific embodiment in which the invention may be practiced. This embodiment is described in sufficient detail to enable one skilled in the art to practice the invention. It will be understood that other embodiments may be utilized and that structural changes may be made without departing from the spirit and scope of the present invention. The following detailed description is, therefore, not to be taken in a limiting sense.

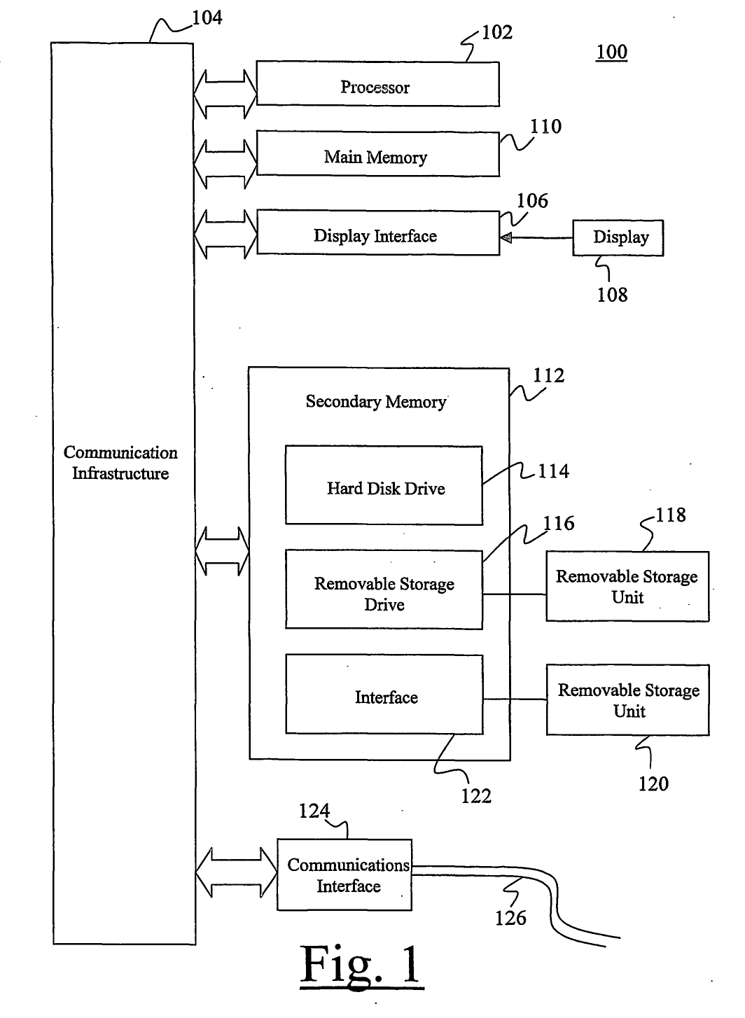

The present invention may be implemented using hardware, software or a combination thereof and may be implemented in one or more computer systems or other processing systems. In fact, in one embodiment, the invention is directed toward one or more computer systems capable of carrying out the functionality described herein. An example of a computer system 100 is shown in FIG. 1. Computer system 100 includes one or more processors, such as processor 102. Processor 102 is connected to a communication infrastructure 104 (e.g., a communications bus, cross-over bar, or network). Various software embodiments are described in terms of this exemplary computer system. After reading this description, it will become apparent to a person skilled in the relevant art(s) how to implement the invention using other computer systems and/or computer architectures.

Computer system 100 can include a display interface 106 that forwards graphics, text, and other data from communication infrastructure 104 (or from a frame buffer not shown) for display on a display unit 108.

Computer system 100 also includes a main memory 110, preferably a random access memory (RAM), and may also include a secondary memory 112. Secondary memory 112 may include, for example, a hard disk drive 114 and/or a removable storage drive 116, representing a floppy disk drive, a magnetic tape drive, an optical disk drive, etc. Removable storage drive 116 reads from and/or writes to a removable storage unit 118 in a well-known manner. Removable storage unit 118, represents a floppy disk, magnetic tape, optical disk, etc. which is read by and written to by removable storage drive 116. As will be appreciated, the removable storage unit 118 includes a computer usable storage medium having stored therein computer software and/or data.

In some embodiments, secondary memory 112 may include other similar means for allowing computer programs or other instructions to be loaded into computer system 100. Such means may include, for example, a removable storage unit 120 and an interface 122. Examples of such may include a program cartridge and cartridge interface (such as that found in video game devices), a removable memory chip (such as an EPROM, or PROM) and associated socket, and other removable storage units 120 and interfaces 122 which allow software and data to be transferred from removable storage unit 120 to computer system 100.

Computer system 100 may also include a communication interface 124. Communications interface 124 allows software and data to be transferred between computer system 100 and external devices. Examples of communications interface 124 may include a modem, a network interface (such as an Ethernet card), a communications port, a PCMCIA slot and card, etc. Software and data transferred via communications interface 124 are in the form of signals, which may be electronic, electromagnetic, optical or other signals capable of being received by communications interface 124. These signals are provided to communications interface 124 via a communications path (i.e., channel) 126. Channel 126 carries the signals and may be implemented using wire or cable, fiber optics, a phone line, a cellular phone link, an RF link or other communications channels.

In this document, the terms “computer program medium” and “computer usable medium” are used to generally refer to media such as removable storage drive 116, a hard disk installed in hard disk drive 114, and or signals. These computer program products are means for providing software to computer system 100. The invention is directed to such computer program products.

Computer programs (also called computer control logic) are stored in main memory 110 and/or secondary memory 112. Computer programs may also be received via communications interface 124. Such computer programs, when executed, enable computer system environment 100 to perform the features of the present invention as discussed herein. In particular, the computer programs, when executed, enable processor 102 to perform the features of the present invention. Accordingly, such computer programs represent controllers of computer system 100.

In an embodiment where the invention is implemented using software, the software may be stored in a computer program product and loaded into computer system 100 using removable storage drive 116, hard disk drive 114, or communications interface 124. The control logic (software), when executed by processor 102, causes processor 102 to perform the functions of the invention as described herein.

In yet another embodiment, the invention is implemented using a combination of both hardware and software.

In accordance with one embodiment of the present invention, a component-based architecture development environment 200 comprises a graphical user interface (GUI) 202, a component manager 204, an instance manager 206, and a deployment manager 208.

GUI 202 provides a graphical display of a development environment 200 to a user for manipulating interactions between components. The structure and operation of GUI 202 is disclosed in further detail in the “GUI 202” section of this disclosure.

Component manager 204 manages the component registration process for registering components for use in creating software scripts. In this document, the terms “script” and “component tree” are used interchangeably. The structure and operation of component manager 204 is disclosed in further detail in the “Component Manager 204” section of this disclosure.

Instance manager 206 manages component interactions in the current script. The structure and operation of instance manager 206 is disclosed in further detail in the “Instance Manager 206” section of this disclosure.

Deployment manager 208 manages the build and deploy process of the current script to a component-based architecture. The structure and operation of deployment manager 208 is disclosed in further detail in the “Deployment Manager 208” section of this disclosure.

1. GUI 202

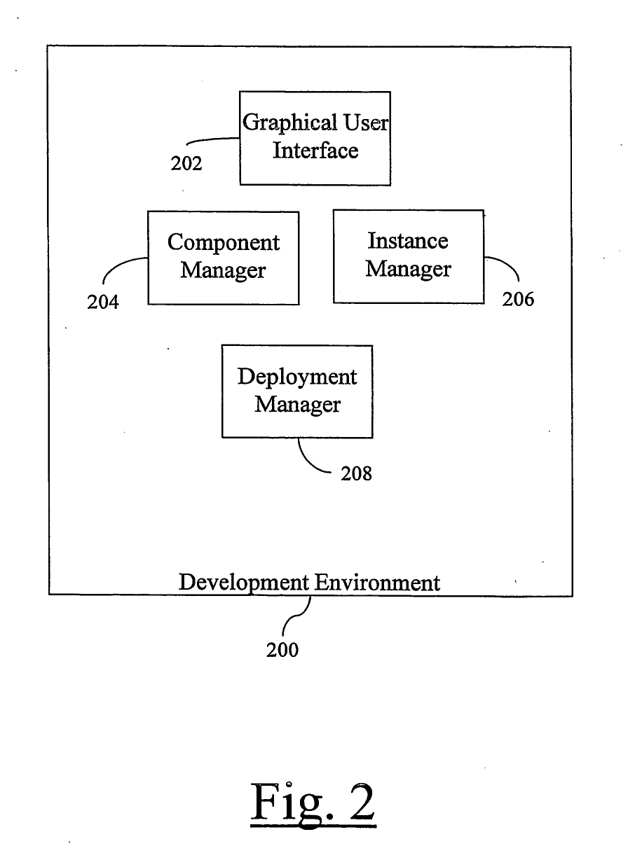

FIG. 2 shows GUI 202 in accordance with one embodiment of the present invention. GUI 202 is a refined 3D graphical interface that allows users to build and test scripts on the fly without keying in lines of code. GUI 202 comprises a canvas 302, an interacts area or window 304, a drop-down menu toolbar 306, and a fast access toolbar 308.

Canvas 302 provides screen space for displaying a script's component tree. Canvas 302 provides an area for the user to manipulate and define component interactions, thereby building the component tree of a script. A component tree on canvas 302 consists of one or more software components. Unlike much of the prior art which uses interfaces that “wire” components together, or interfaces providing a physical view of the graphical windows and components of the application being built, the present invention displays a hierarchal tree format representing a component script showing not just which components interact but also how they interact. The hierarchal tree comprises multiple hierarchal levels, each level comprising one or more components. An interaction, or connection, between one component of one hierarchal level and one component of another hierarchal level is shown as a function of a method to be invoked at runtime by the script.

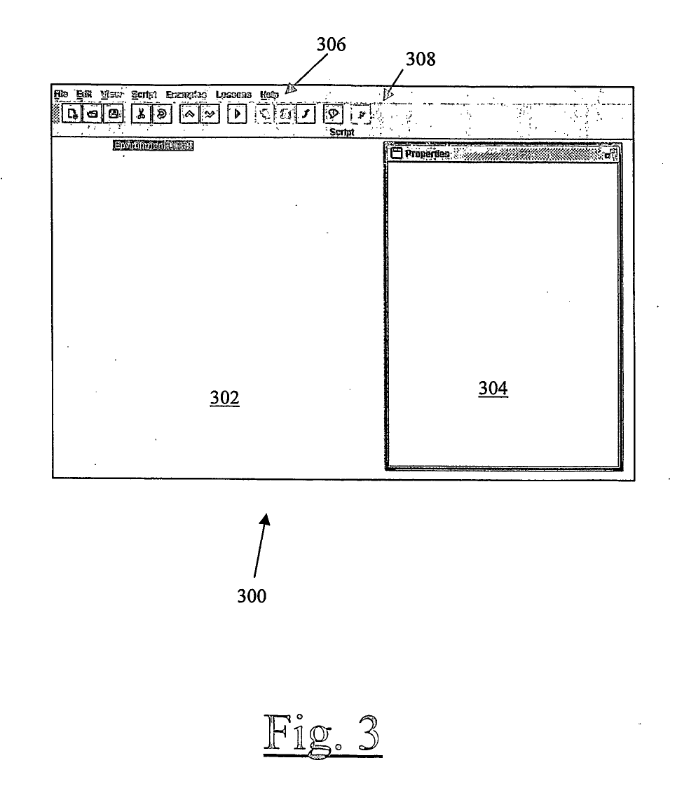

The highest hierarchal level of a component tree consists of a single, root component. In one embodiment of the invention, its root component will be an Environment component regardless of a script's purpose. As shown in the example of FIG. 3, canvas 302 has an Environment component in the component tree.

Interacts window 304 is a modeless window which displays method selections available to define the interactions between components of different hierarchal levels. To manipulate the behavior or extend the logic of a component tree, a user selects an existing component from the tree on canvas 302. Interacts window 304 only displays the methods that may be invoked by the selected component. A user-actuated selection of one of these methods expands the selection to reveal a list of registered components that may be passed as the method's parameter (often referred to as the method's “argument”). A user-actuated selection of the component will set it to the current script. The selected method defines the interaction, which is visually displayed to the user, between the existing component and this new component.

Many components can only be configured in specific interactions as governed by their interface definition. For example, because a scroll bar may appear within a window, a Window component would have a method that takes a ScrollBar component as its parameter. In contrast, a window would never appear inside a scroll bar, so the ScrollBar component would never have a method that takes a Window component. Development environment 200 implements these configuration rules for the user in accordance with a component framework disclosed herein. Development environment 200 automatically identifies components having compatible interfaces, so that a script is as fault tolerant as the encapsulated functionality of the components themselves.

Drop-down menu toolbar 306 comprises a series of drop-down menus for managing development environment 200. These menus include importing scripts, building and deploying scripts, running scripts, accessing help files and examples, etc.

Fast access toolbar 308 includes icons for quick access to some of the more frequented options available from drop down menu 306.

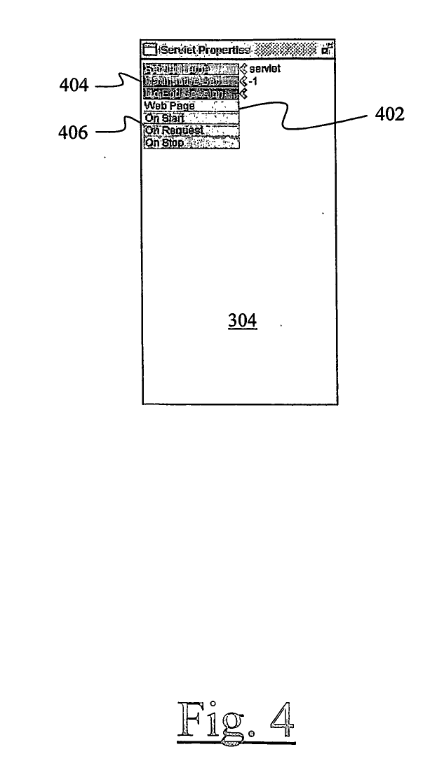

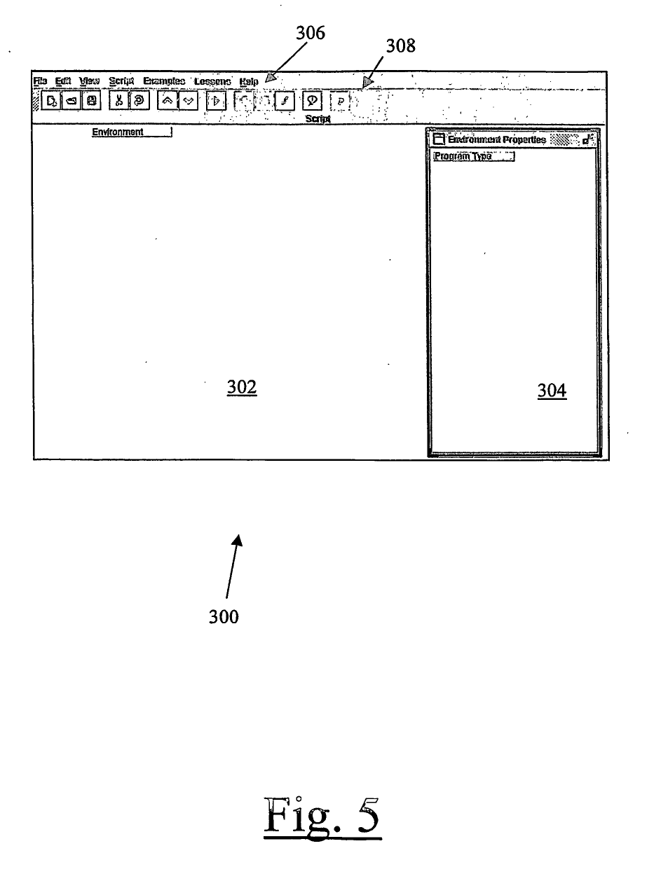

Referring now to FIG. 4, there are generally three types of method selections that a user may find in interacts window 304: Component method selections 402, Property method selections 404, and Command method selections 406.

Component method selections 402 comprise component methods that set a new component into the script. A new component is instantiated as a child component of a parent, wherein child components extend the logic capability of their parent component. Child components react differently depending on their parent component. For example, a WebPage component may be added to an existing Servlet component.

Property method selections 404 include property methods that set a value to a property, which is an atomic, immutable element that defines a component. For example, a HTMLPage component may have a Title property, or a BackgroundColor property, each set by a property method. Or, a property may also denote action in its parent component by notifying it that an event needs to be handled. For example, a HTMLPage component may have a DoFocus property that is triggered by another component. Hereinafter, this type of property will be referred to as a “trigger”. According to one embodiment, names of triggers generally begin with a “Do” in their title.

Property methods set the property by receiving data from one of two special components: a link component or a link constant component.

A link defines a property whose value is asserted by another component of the component tree. That is, the property of a component is set dynamically during execution of a script. Links can be either of the input or output type, and a link of one type is connected to a link of the other type. For example, an HTMLPage component's Title property may be set by an input link connected to an output link of a Database component. Triggers always have a link component set as their child component.

A link constant defines a property statically, the value being set by the user. A link constant stores a static value for the parent component. For example, a user may set an HTMLPage component's Title property to “My Home Page”. This value remains static during execution of the script.

Command method selections 406 include command methods that denote action within the component structure itself. A command method's name generally begins with “On”, for example, OnConnect or OnStart. A command method generates action by its parent component. For example, a Database component may invoke an OnConnect command method that, once the script connects to a database via a Database component, sets up an XML Producer component to log data transactions to an XML file. A command method can also trigger action in another component in cooperation with the link components. For example, a HTMLPage component may have an OnRefresh command that, when a user refreshes the page, triggers an event in a Database component.

The true flexibility and simplicity of the present invention may best be disclosed through an example. The following example is for explanatory purposes only, and is not intended to limit the invention in scope, nor should it be taken in a limiting sense.

To build a script from scratch, a user selects the root component to show the methods available thereto as illustrated by FIG. 5. Interacts window 304 shows one method displayed as “Program Type” which, when invoked by the Environment component, sets a new component to the script. Represented by the hierarchal tree, this new component falls to the next hierarchal level. The ProgramType method is of the component method-type.

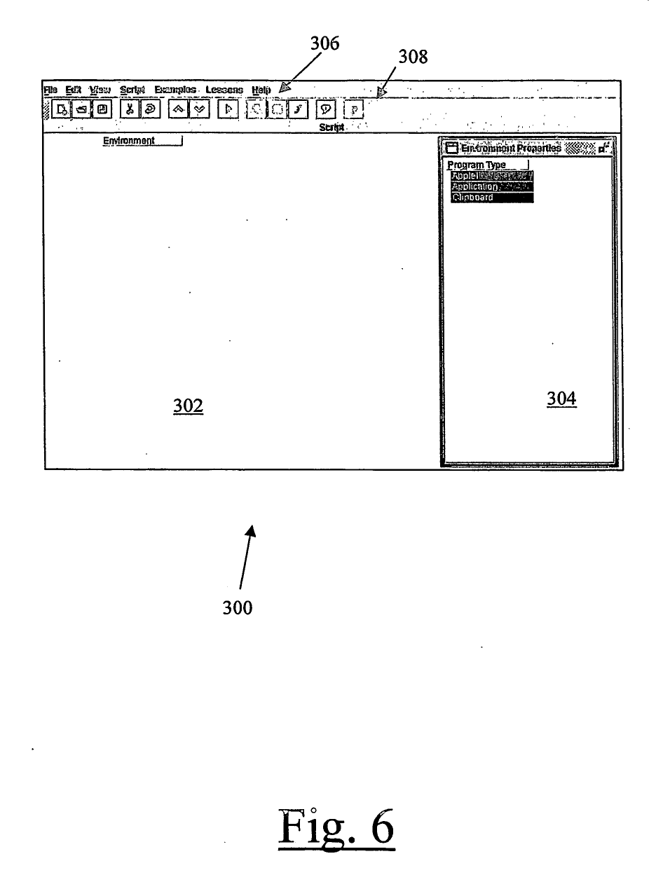

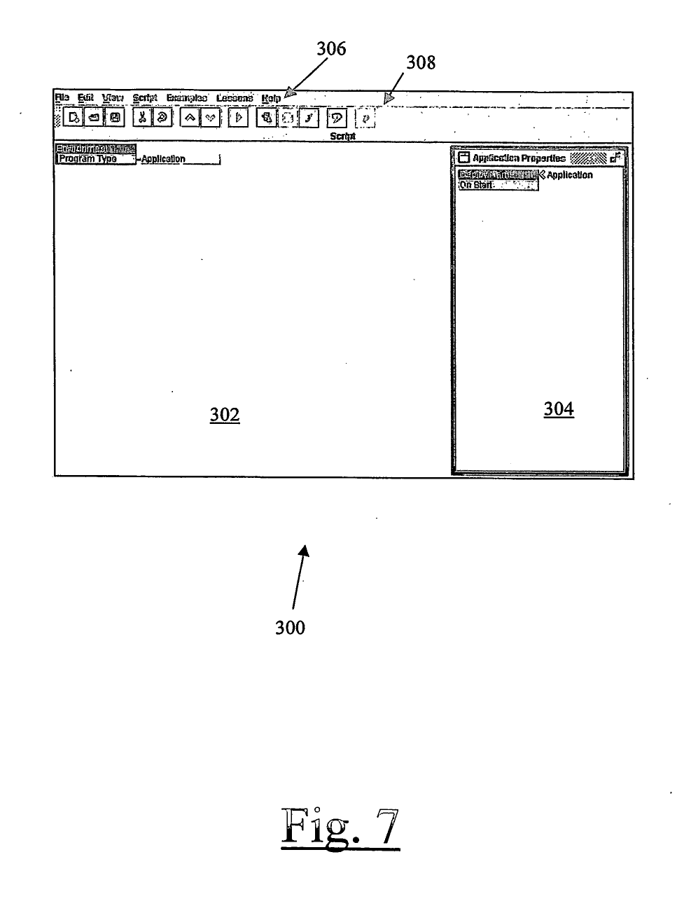

As shown in FIG. 6, clicking on the ProgramType method reveals three components that the ProgramType method may receive as its parameter: an Applet component, an Application component, or Clipboard component. While the present embodiment shows three compatible components that are registered, it is important to note that a novel feature of the present invention is the ability to register and incorporate new components to extend the flexibility of development environment 200. There is no limit to the number of components that may be attached to the root component. Because the tree starts not from the application level or applet level, but at an environment level, it permits multiple applications or applets in the same hierarchal tree. It is possible for multiple applications or applets under the same root component to work synergistically. For example, one application could provide server services while another could provide client services. By running the script, the server and client services could interact and share data therebetween.

Selecting the Application component sets it to the component script. As FIG. 7 shows, canvas 302 is updated to reflect this action. The component script has two hierarchal levels, wherein the interaction between the Environment component and the Application component is defined by the ProgramType method. Selecting the Application component of the component tree reveals two methods in interacts window 304: a DeployName property method and an OnStart command method.

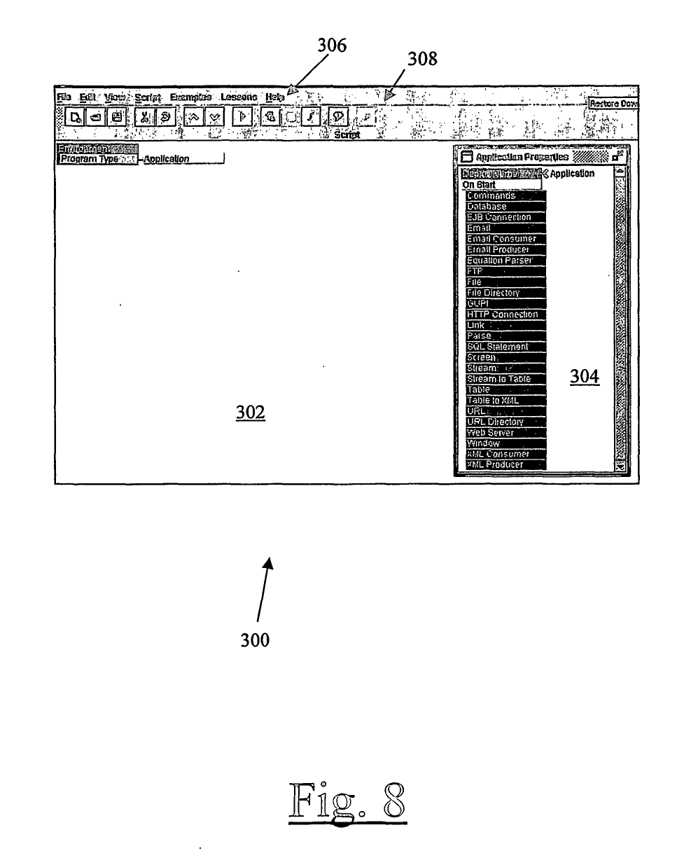

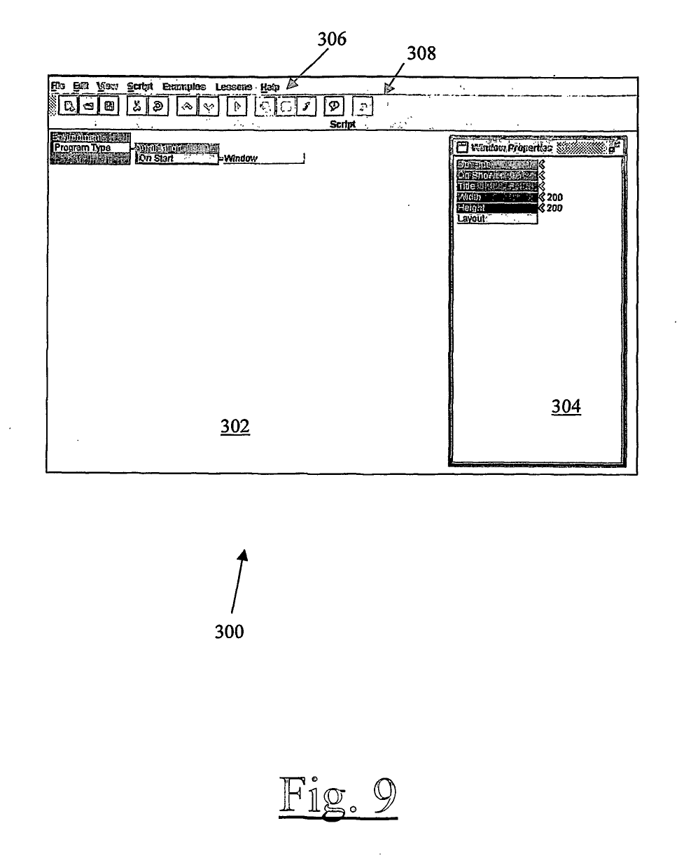

FIG. 8 shows interacts window 304 after a user has selected the OnStart method. The OnStart method receives a component that is instantiated at the initial execution of its parent component.

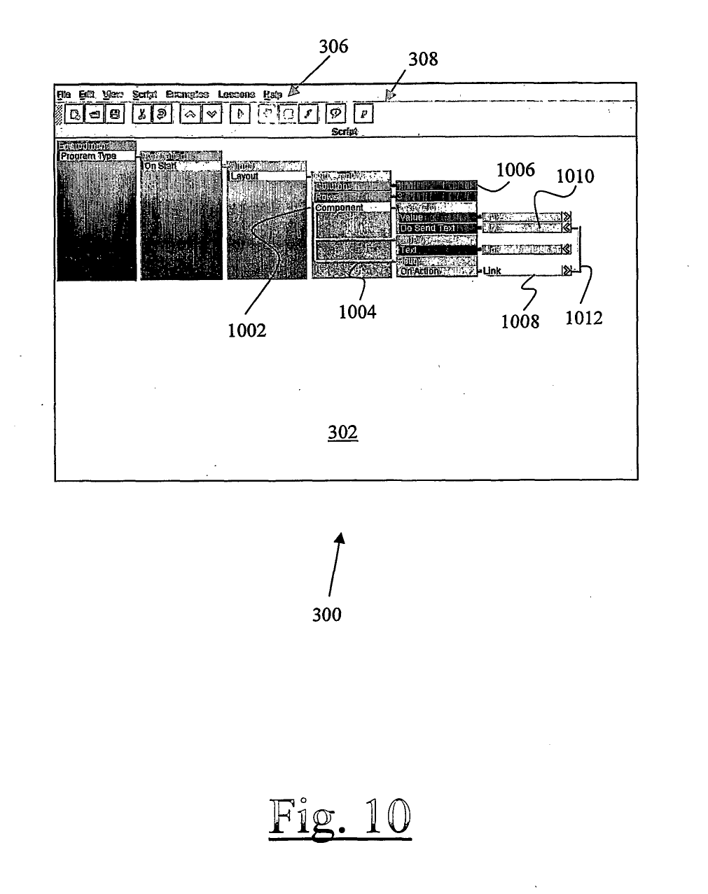

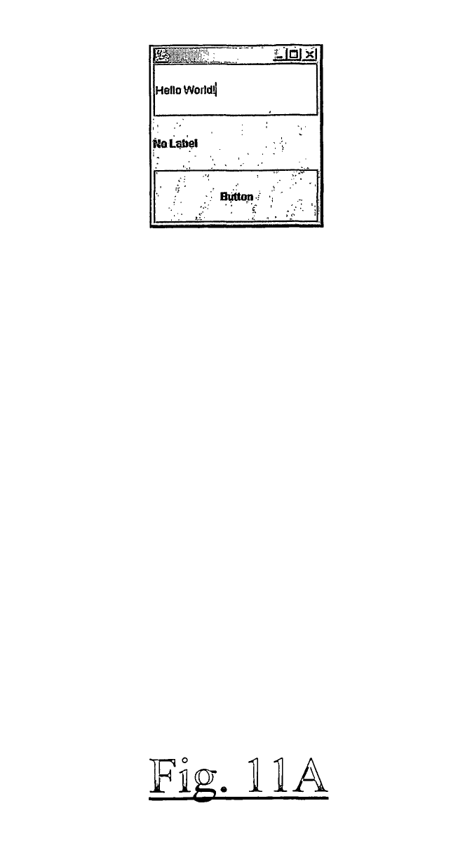

FIG. 9 shows an updated canvas 302 after a user has selected to pass the OnStart method a parameter of the Window component type. It should be appreciated that although not illustrated by example, multiple OnStart methods can be selected to be invoked by the Application component. At runtime, each invoked method receives the respective component so that a user can choose to create multiple windows at boot of the compiled script, or a variety of differing components, such as a Webserver component and a Database component. This is true of any combination of methods and their arguments as can be seen in FIG. 10.

FIG. 10 shows canvas 302 after the user has set several components to build the component tree. Method 1002 will be invoked three times by the GridLayout component during runtime execution, which is indicated using connect bars 1004 for GUI 202 refinement and simplicity. Each method invocation receives a different component as its argument, demonstrating the versatility and modularity of the present invention's component-based architecture development environment 200.

Also, FIG. 10 shows GUI 200 displaying a constant link component 1006 and a link component 1008, 1010 in the component tree. Constant link component 1006 has a static value set thereto, which is displayed to the user. In this example, constant link 1006 has a value of “1”. Link component 1008 is dynamically set by connecting to link component 1010 with connect bar 1012. Small arrows on each link component 1008, 1010 indicate the direction of data flow. In this example, a running script will perform the On Action method of the Button component, which triggers the Do Send Text trigger property of the Text Field component.

As FIG. 10 illustrates, the connect bars of other link components are hidden from view until a user selects one of the link components. Upon selection, the currently displayed connect bar will be hidden, and the connect bar of the selected link component will be displayed to show any interaction. Without this hide and reveal feature, canvas 302 may become overcrowded, making it difficult for a user to trace component interactions. Also of note is that connect bars 1004 group multiple components to a single method 1004 for display simplicity.

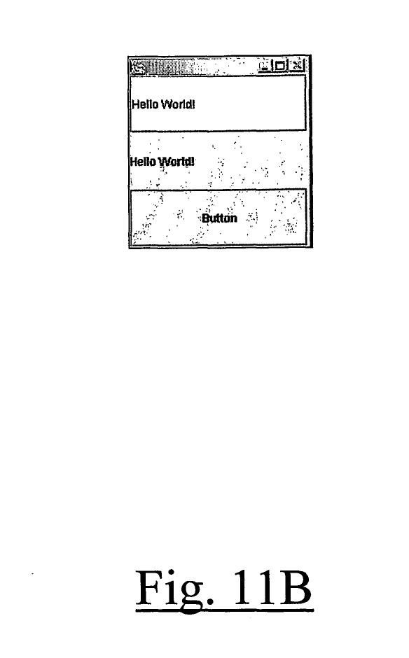

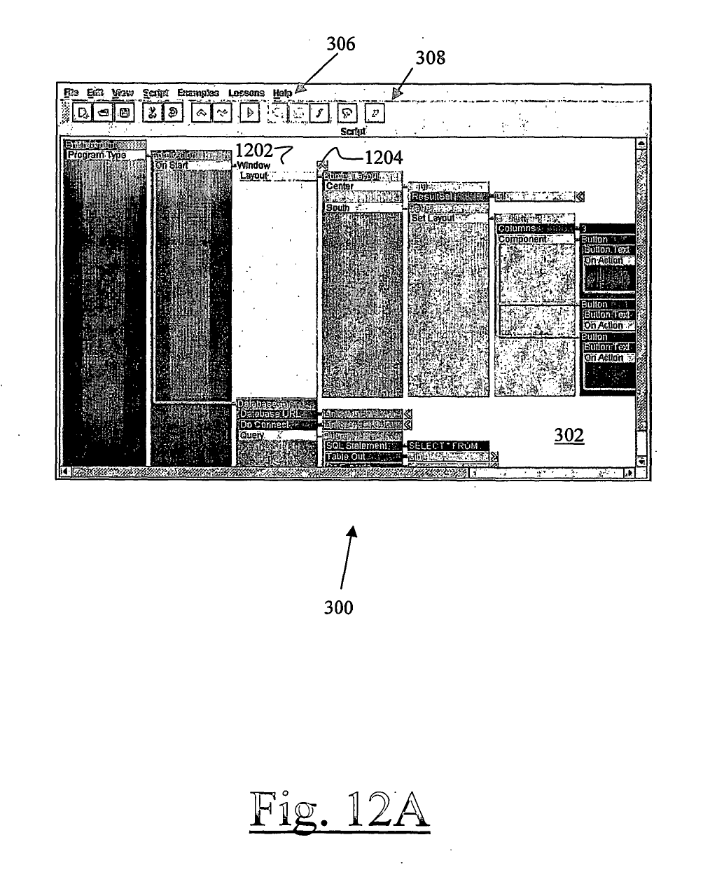

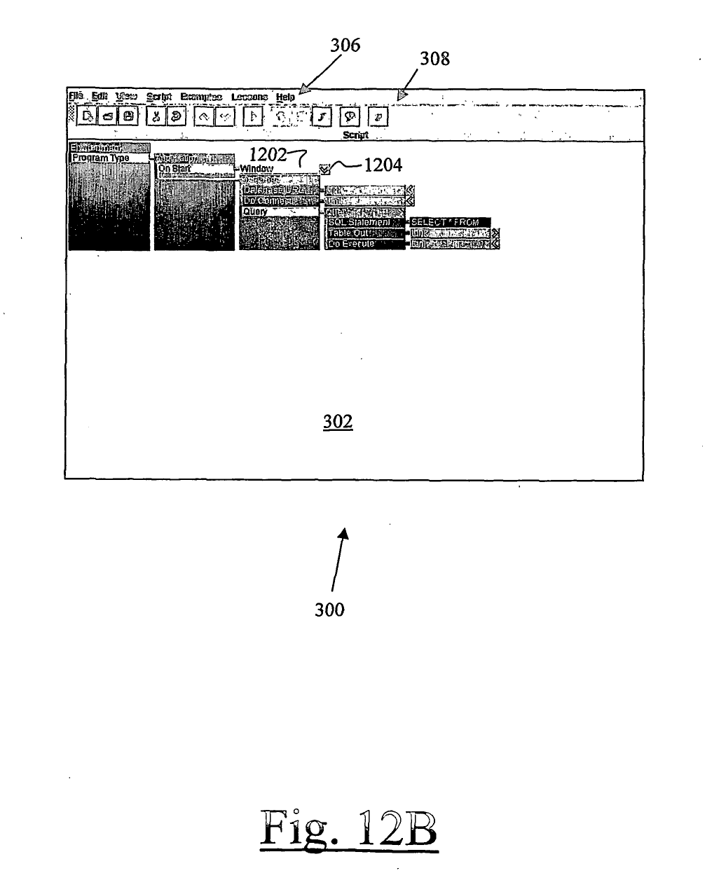

FIG. 11A-B shows the running script of FIG. 10. The script is being run within development environment 200, and has not been separately deployed. In this running script, a user can type text into the text field of FIG. 11A. At the press of the button at the bottom of the window, the label is updated with text from the text field as shown in FIG. 11B.

In addition to those features already described, there are several other features promoting the efficient use of space on canvas 302. These features are especially useful when working with complex scripts having large component trees.

GUI 200 includes a feature for hiding and revealing select portions of the component tree. Components below a user-selected component in the hierarchal tree may be toggled between a hidden state and a revealed state.

FIG. 12A shows a large component tree in which screen real estate is scarce. Only a portion of the component tree is visible to the user at any one time. While standard scroll bars at the bottom and right side of the window make navigation possible, it remains difficult to fully appreciate the complexities and intricacies when manipulating components of the tree. Selecting any component of the tree, such as selected Window component 1202, reveals a toggle button 1204. Toggle button 1204 points in the upward direction, indicating that Window component 1202 is in the revealed state in which components below Window component 1202 are displayed.

Selecting toggle button 1204 switches Window component 1202 to the hidden state as shown in FIG. 12B. All components below Window component 1202 are hidden, making navigation and study of the component tree more manageable. Toggle button 1204 now points downward, signifying Window component 1202 is in the hidden state.

Second, GUI 200 includes a feature for expanding and collapsing a tree. A user can perform a “click-and-hold” action with a mouse pointer on canvas 302 and drag left or right to expand or collapse the component tree in real time, enabling an unlimited number of intermediate positions in which a user may situate the tree.

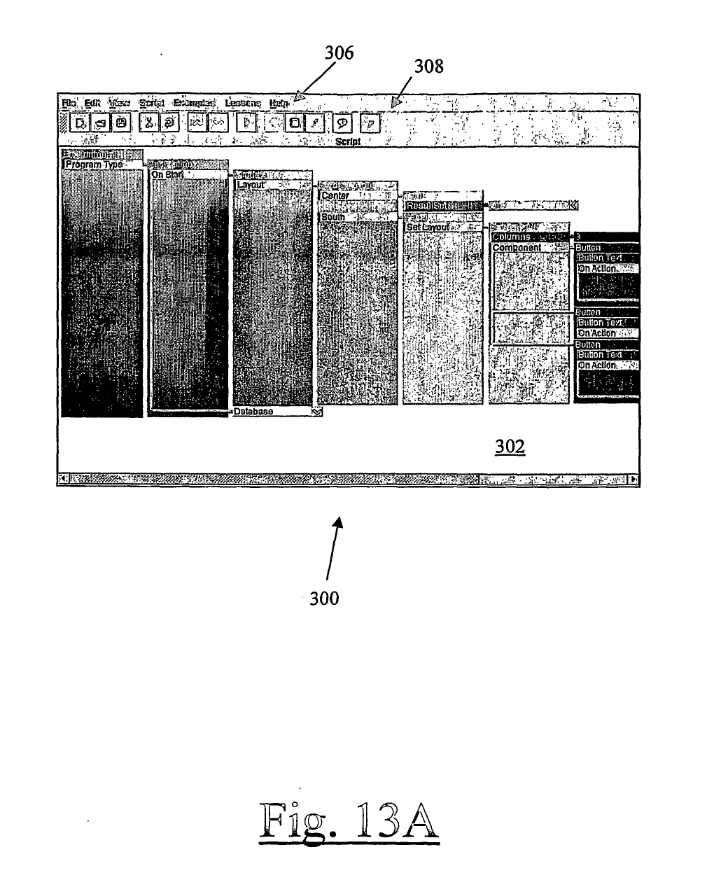

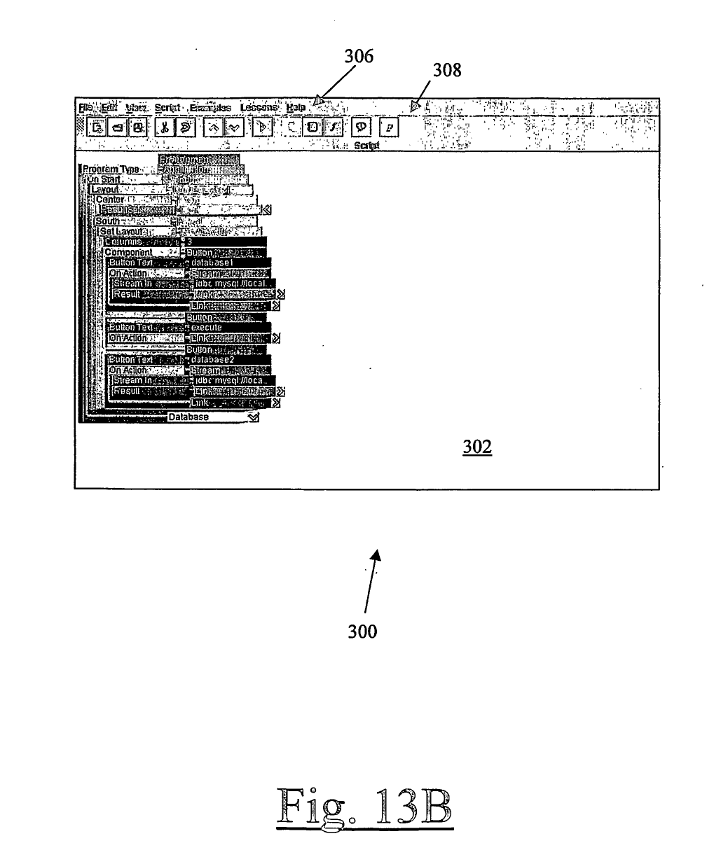

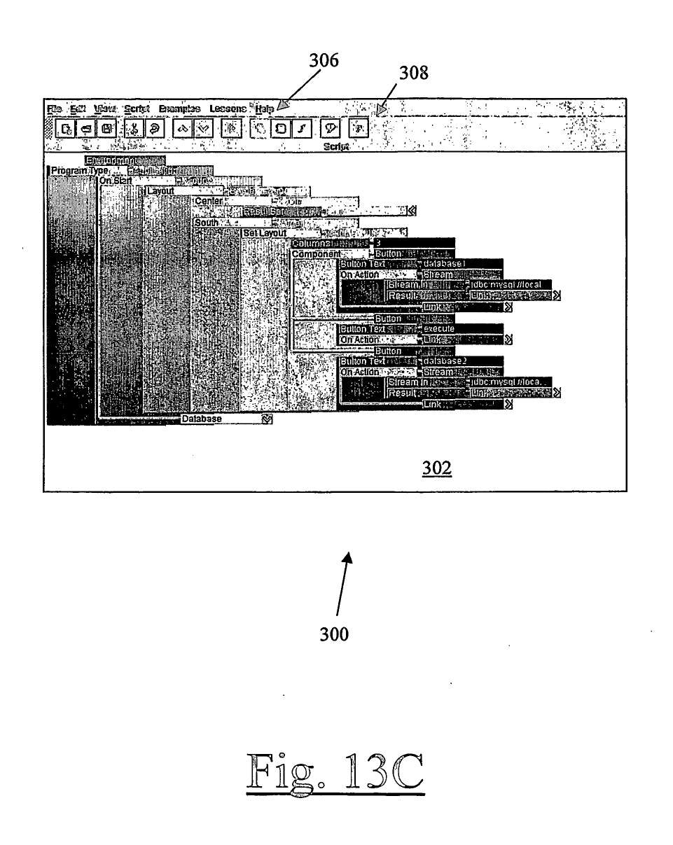

FIG. 13A shows a tree in a fully expanded state. As the tree becomes more complex, it may be beneficial to the user to collapse the tree so that more comes into view on canvas 302.

FIG. 13B shows the component tree in a fully collapsed state. However, if the user prefers, any number of intermediate positions between a fully expanded state and fully collapsed state can be achieved with the present invention. This feature has the advantage of customizing the size of the tree to the size of canvas 302. FIG. 13c shows just one of these intermediate positions. The component tree remains fully interactive at any of these positions.

GUI 202 includes a “Run” button to run a script on canvas 302. Development environment 200 has the capacity to allow components of a running script to be modified on-the-fly without stopping the script execution. This enhances a user's ability to efficiently debug the script, without having to spend time stopping, recompiling, and re-running the script. Components can be added, deleted, or moved while a script runs. If the script is running and the component tree is modified, development environment 200 reacts to the changes by incorporating them into the currently running script. The script can be stopped at any time by clicking on a “Stop” button on toolbar 308 or a “Stop” selection from drop-down menu 306.

At the direction of a user, a script on canvas 302 can be built and deployed using a “one-click” deployment process. To use, the user simply selects the component to be deployed in the component tree, and then one-clicks a “Build and Deploy” button on toolbar 308 or a “Build and Deploy” selection from drop-down menu 306. The deployment process traverses each component of the component tree, wherein each component is responsible for compiling its own source code (if it is a compilable language). Each component is responsible for incorporating all supporting files.

Each component has a build method encapsulated therein which generates compiled code based on the parameters reflected in the component tree. Servlets, EJBs, portlets to a webserver, HTML files, or XML files may be built and deployed in this manner, as well as any other type of software. UNIX shell and PERL scripts could be generated on the fly using this technique. The deployment process will be further appreciated upon full disclosure of the present invention.

GUI 202 provides the ability to create a function from a portion of a script. This feature makes it simple to reuse commonly arranged components in multiple scripts without having to rebuild the functional arrangement each time. A function is a group of components that can be loaded into other scripts collectively with their interconnections preserved. The process for creating a function includes two steps: an externalize step and a function creation step.

GUI 202 provides an “Externalize” button or selection for execution for the externalize step and a “Create Function” button or selection for execution of the function creation step. A component is selected by the user to be externalized before the function is created. Externalizing provides an exception for the collective grouping of the selected component's parent's method. For example, if a user wants to create a function which included an HTMLPage component having a set color and header, but wanted to allow someone to add components under it, the user would create an HTMLPage component, set its color and header property components, and add a child component such as a Table component using a AddComponent method. The user would then externalize the Table component by selecting it in the tree and selecting the “Externalize” button or selection. A user may then execute the function creation step by selecting the HTMLPage component and selecting the “Create Function” button or selection. The HTMLPage component and all components below in the hierarchal level are collectively saved as a function with the exception of the externalized Table component. The user has the option to name the function before it is saved. Once the function is created and saved, it will appear in Interacts window 304 identified by its user-defined name and in association with methods taking an HTMLPage component parameter. If a user adds the user-defined function to a script, the tree on canvas 302 is updated and Interacts window 304 shows only the externalized methods as method selections, which in the current example is the AddComponent method. The color and title properties are statically set as before and cannot be changed.

2. Component Manager 204

One familiar in the art will fully appreciate the component registration process managed by component manager 204 upon disclosure of the novelty of the component framework used in accordance with one embodiment of the present invention.

FIG. 14 shows a component framework 1400 supported by development environment 200 for building software scripts. Framework 1400 provides for the separation of a component's implementation and corresponding interface definition. The flexibility and interactivity of the component-sharing feature of the present invention is then possible. Framework 1400 contains the necessary files for importing components into development environment 200 for building and manipulating functions or scripts. Component framework 1400 comprises one or more components 1401a-1401n, each having a three-tier architecture comprising a component binary 1402, a component wrapper 1404, and an interface definition file 1406.

Component binary 1402 comprises the implementation portion of framework 1400. Component binary 1402 is a compiled object class that implements the methods, properties, and events encapsulated therein. In accordance with industry software component standards, component binary 1402 is capable of encapsulating any functionality written in any programming language on any system framework so as to preferably provide complete portability of framework 1400 to any platform. The extent of functionality encapsulated by component binary 1402 is not limited, so that any type of script may be created by a combination of components. There are no limits on complexity or simplicity. For example, component binary 1402 may encapsulate a webserver, applet, webpage, scroll bar, hyperlink, graphic, etc.

Component binary 1402 abstracts to component wrapper 1404 which comprises the interface portion of component 1401. Component wrapper 1404 permits component binary 1402 to interface with development environment 200. This abstraction allows any component binary 1402 to be registered in development environment 200 without having to be rewritten or altered at the component level. Development environment 200 advantageously exploits the interface abstraction to wrapper 1404 to provide more direct control over interactions between component binaries 1402. Under component framework 1400, any interactions in a running script between a plurality of component binaries 1402 pass data to their respective wrappers 1404, where the data exchange can be directly managed by development environment 200.

If the particular component 1401 is deployable, component wrapper 1404 will have an individual build method for building and deploying component binary 1402 in a script. Therefore, each component 1401 can have different build methods for appropriately deploying corresponding component binary 1402 in a deployment process.

The interface of component binary 1402 abstracted to component wrapper 1404 is still further abstracted to interface description file 1406.

Each component wrapper 1404 has a corresponding interface description file 1406 comprising the interface definition portion of component 1401. Description file 1406 is of a proprietary file type describing the interface of component wrapper 1404 with a description schema in a structured markup language. In the present embodiment, a description in eXtensible Markup Language (XML) is encoded in description file 1406 that can be read and written by development environment 200. Description file 1406 describes the interface of the associated wrapper 1404. By defining the interface in a structured markup language, development environment 200 (or other tools) do not have to be pre-programmed to be familiar with a particular component wrapper 1404. Instead, the interface is loaded from interface description file 1406 to register component wrapper 1404 and corresponding component binary 1402 with development environment 200. In this manner, component 1401 becomes registered.

Different technology zones can share logic seamlessly, for example, over a network. The markup language of interface description file 1406 facilitates the exchange of components 1401 over a network. A user can view meta-information about component 1401 from description file 1406 before using in a script. The structured markup language encoded in description file 1406 allows for easy conversion to tools other than development environment 200.

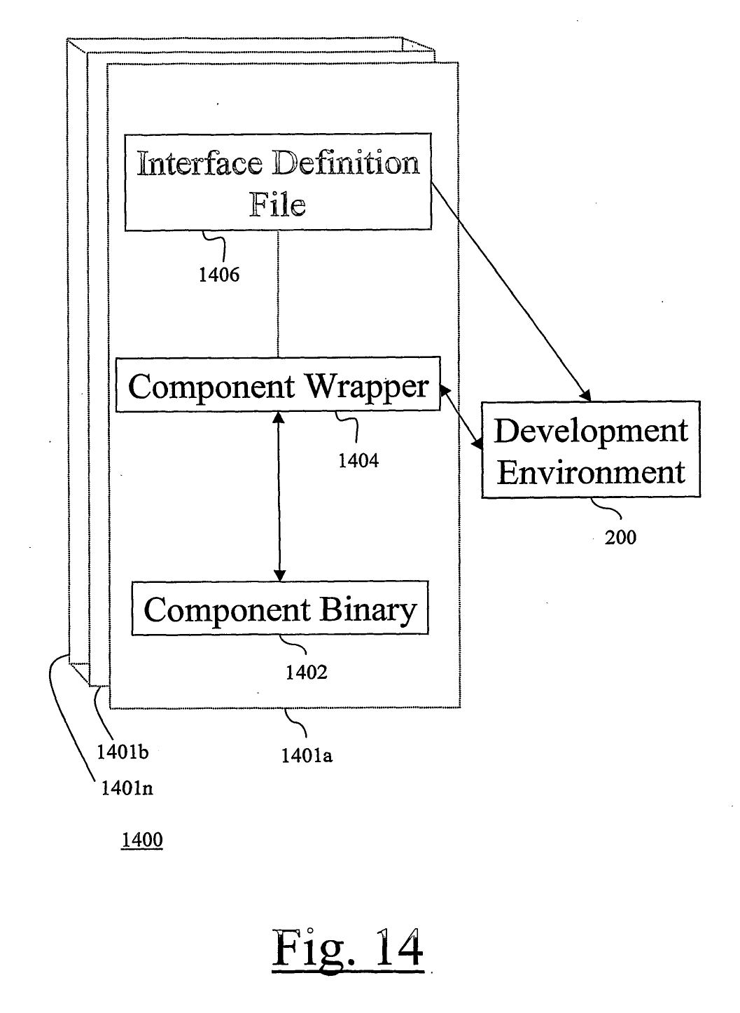

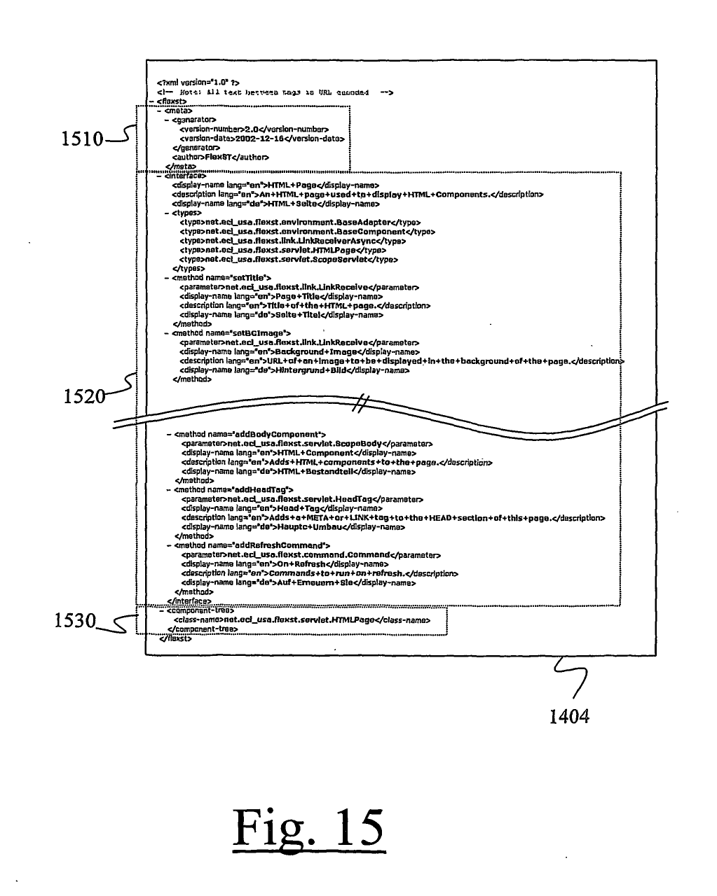

Description file 1406 includes three main sections each shown in FIG. 15: a meta section 1510, an interface section 1520, and a component-tree section 1530.

Meta section 1510 contains basic meta-information about interface description file 1404. Meta section 1510 describes which version of development environment 200 generated description file 1406 (including version number and date), the author, and optionally, the last modified user. Meta section 1510 plays an important role if component is being shared over a network with other users. In the present embodiment, meta section 1500 is denoted by <meta> and </meta> tags.

Interface section 1520 provides the interface definition for the associated component wrapper 1404 by identifying its methods. In the present embodiment, Interface section 1520 is denoted by <interface> and </interface> tags.

Interface section 1520 includes at least one display-name section identifying the name of the associated component 1401, and at least one description section providing a brief summary of the associated component's capabilities. These sections are used for display on GUI 202 of development environment 200, so that a user may identify and choose components for creating a script, or for self-generating “Help” files. The example of FIG. 15 shows a description file that is describing the interface for a component wrapper 1404 of an HTMLPage component 1401. Interface section 1520 may include multiple display-name sections and multiple description sections for more than one language.

Interface section 1520 further includes a types section comprising one or more type sections, each type section identifying a class of which the present component wrapper is an inheriting subclass. Methods that may be passed those object types identified in the types section of this or other components will accept this component 1401.

Following the types section, interface section 1520 consists of one or more method sections. Each method section identifies an attachment point into component wrapper 1404 that another component wrapper 1404 can attach to. Therefore, component wrappers interconnect the underlying component binaries 1402 in development environment 200. The method section identifies the name of a method encapsulated in component wrapper 1404 that interfaces with development environment 200. Each method section further comprises one or more parameter sections, display-name sections, and description sections.

The parameter section identifies the object type passed to the method at invocation. This parameter section, in conjunction with another wrapper's interface type sections, dictates which interactions can exist between components 1401. Only wrappers 1404 with the identical class or subclass encoded in the interface types section are compatible with the method. In the example of FIG. 15, one method encoded is a setTitle method which takes an object of the LinkReceive type. This indicates that component wrapper 1404 implements a method named “setTitle” which takes component wrappers 1404 with a LinkReceive interface type. Thus, component binaries 1402 having compatible component wrappers 1404 can be interconnected.

Information encoded in display-name and description sections are presented on GUI 202 of development environment 200 so that a user may identify and choose methods of the present component for building a script, or for self-generating “Help” files.

Component-tree section 1530 comprises a class-name section identifying corresponding component wrapper 1404. In the present embodiment, component-tree section 1530 is denoted by <component-tree> and </component-tree> tags.

The example of FIG. 15 shows description file 1406 of the component-type, which is included in component 1401 of component framework 1400. There are two additional variations of this file: a script-type for defining a component script and a function-type for defining a function.

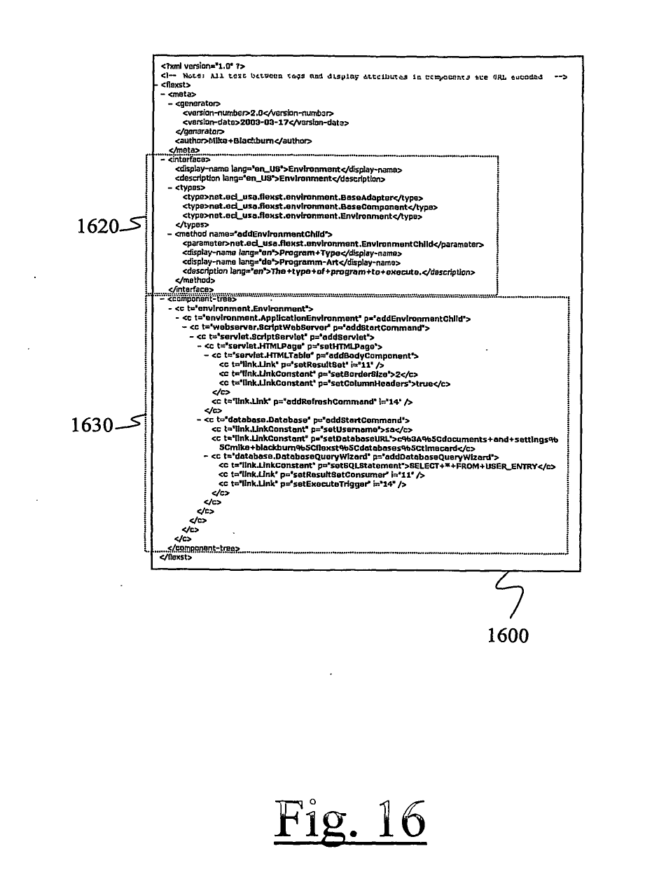

A script-type file provides the information necessary to reconstruct a user-built script that may have been written during a previous authoring session. A script file includes data necessary for assembling components of the user-script in the proper tree configuration within development environment 200. While a script-type file has an identical meta section format as interface description file 1406, variations exist with the format of the interface and component-tree sections. An example script definition file 1600 is shown in FIG. 16.

The interface section of a script-type file identifies the root component of the script and the root component's invocable method(s). Interface section 1620 identifies the root component as an Environment component with an addEnvironmentChild method.

The component-tree section of the script file holds data for reconstructing the tree hierarchy of a saved script. As shown in the example of FIG. 16, the component-tree section of script-type file 1600 begins with a root Environment component. Spawning from the Environment component is an ApplicationEnvironment component. The ApplicationEnvironment component is added to the tree in accordance with the addEnvironmentChild method of its parent Environment component. If links or constants were set in the script, these too are preserved in script file 1600.

A function-type description file is similar to a script-type description file with some exceptions. First, any externalized methods are set as parameters. Second, the component-tree section does not necessarily begin with a root Environment component. Instead, it begins with the first component in the function script.

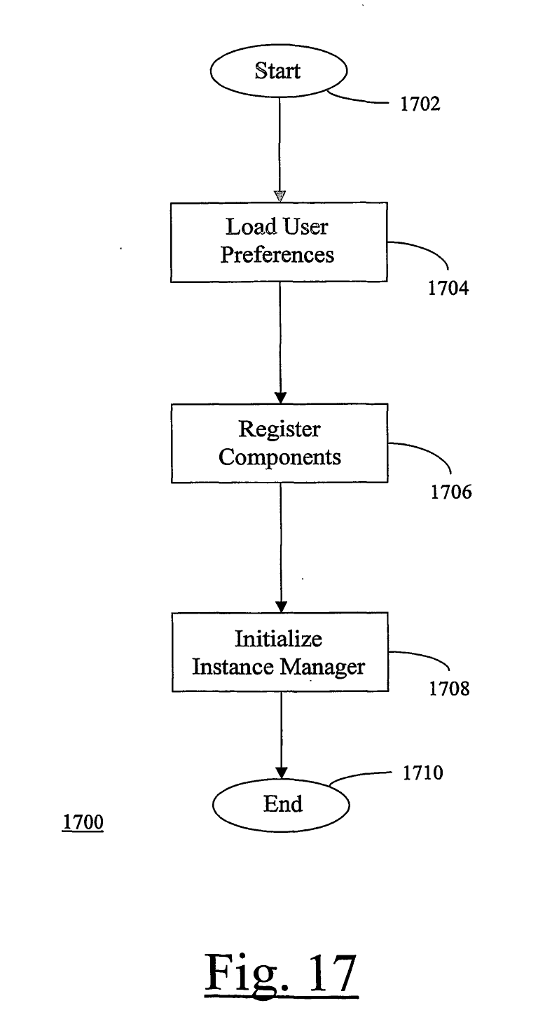

Component manager 204 is an integral constituent of an initialization process 1700 executed by development environment 200 and shown in FIG. 17. Preferably, process 1700 is performed at each boot of development environment 200.

Process 1700 beings at block 1702 and proceeds to control block 1704 at which stored or default user preferences are loaded to development environment 200. Preferences include default and custom graphical window settings including size and position, file paths to directories for storing and retrieving saved scripts, a file path to the compiler, a license server IP address if being hosted by a server (for example, by JAVA WEBSTART), etc. Because development environment 200 reads the preferences file on boot, the user is relieved from the burden of inputting this information each time development environment 200 is used, as well as allowing for a custom graphical look and feel to which the user is accustom.

Once user preferences are loaded and set, components 1401 available to development environment 200 for building and deploying scripts are registered with development environment 200 at control block 1706. Component registration improves the speed and processing efficiency of development environment 200.

Component registration begins with the instantiation of component manager 204, which parses a component registration file that lists the existing components 1401 available to development environment 200. In one embodiment, this component registration file is initially generated by a search of the local system for components 1401. It should be appreciated that in other embodiments, the component registration file may be alternatively generated such as, for example, searching a network for existing components.

Once parsed, component manager 204 creates a component data object for each component 1401 identified in the registration file. Each component's corresponding interface definition file 1406 is parsed and stored in volatile memory according to the component object data structure. The component object data structure maintains the interface types, display names and descriptions, as well as an object holding the invocable methods of component wrapper 1404.

Using this information, component manager 204 sets two hash tables to volatile memory.

The first hash table has its key holding the names of component wrappers 1404 mapped to their respective component data objects. This first hash table is accessed when running a script and during the one-click deployment process of a script.

The second hash table has its key holding the names of component wrappers 1404 mapped to an array of component data objects stipulated in the interface types sections of corresponding interface definition files 1406. This second hash table is used to quickly and efficiently identify component wrappers 1404 that may be passed as an argument to methods talking the interface types identified in the key. GUI 202 displays the identified components to the user in interacts window 304 when a user selects a method for extending the logic of the component tree. For example, the key of the hash table may hold an EnvironmentChild component whose implementation is a public interface. If an ApplicationEnvironment component and an AppletEnvironment component each implement the EnvironmentChild interface component, then the EnvironmentChild component will be listed in the interface types section of each ApplicationEnvironment and AppletEnvironment interface definition file 1406. Therefore, any method receiving an EnvironmentChild component-type can receive its respective implementations, including ApplicationEnvironment and AppletEnvironment, which are in an array mapped to the EnvironmentChild key of the hash table.

Component registration 1706 is complete once these relationships are mapped in the hash tables.

At block 1708, instance manager 206 is instantiated and initialized. Instance manager 206 handles management duties for a script, including managing component interactions in the script. Instance manager 206 is aptly named because it manages the “instances” of components in a script. On instantiation, instance manager 206 creates an array of instance data objects initially set to hold one instance of the root Environment component. As previously noted, scripts begin with the Environment component. The instance data type is disclosed in further detail in the next section of this disclosure.

Upon completion at block 1710 of initialization process 1700, development environment 200 displays GUI 202 to the user as shown in FIG. 3.

3. Instance Manager 206

A tree's data structure organizes the components of a script and interactions therebetween as defined by their methods. The hierarchal tree's data structure is primarily comprised of two types of data sub-structures, each managed by instance manager 206: an instance data type and a logic node data type.

The instance data type defines each instance of a component in the component tree. The instance data type does not actually implement the methods of a component. Instead, it serves as a holding structure for a component's interface data. Consequently, it merely associates itself with a registered component. When a script runs, the associated component executes its encapsulated code, and its behavior is dictated by any methods invoked thereon as well as the instance's relative position in the component tree.

The logic node data type supports the interaction between two instances, a parent instance and a child instance. The parent instance, child instance, and the method that defines that particular parent-child interaction are included in the logic node data structure.

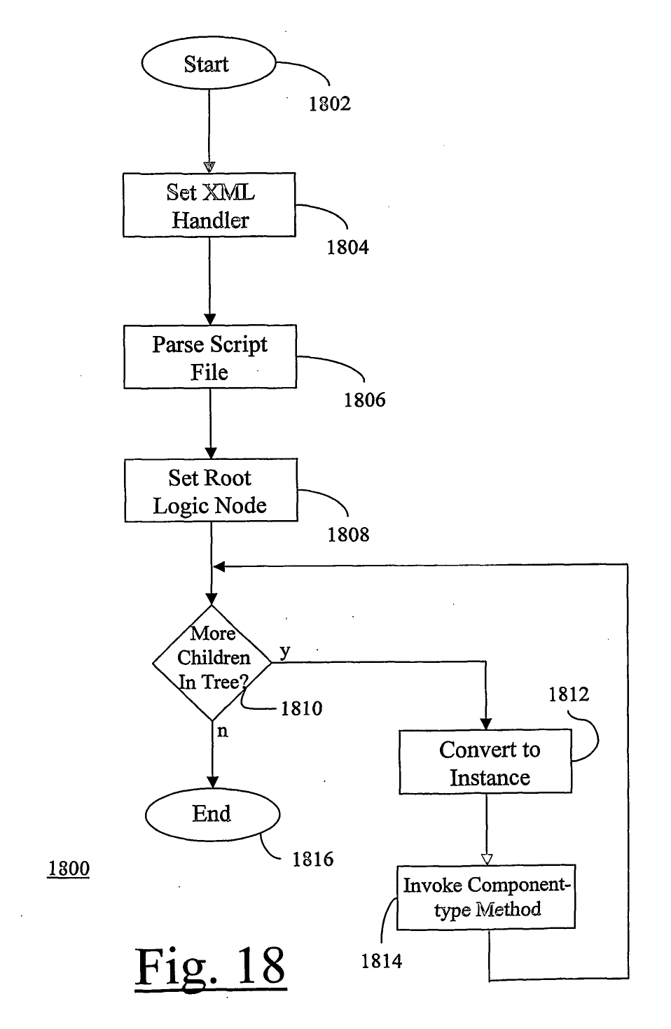

By setting the instance data types and the logic node data types of instance manager 206, a tree may be defined, either from scratch or based on a previously saved script. FIG. 18 shows a flow chart for a script loading process 1800.

Script load process 1800 begins at step 1802 when a user chooses to load a previously saved script. After the user chooses the script file they wish to load, development environment 200 sets an XML content event handler at block 1804. The XML handler is set with markup language parameters for parsing the selected script file. The script file is parsed at block 1806, with component-tree section 1630 set in temporary memory. Because the first component of the component-tree section 1630 is always of the Environment type, this is converted to a logic node data type with its parent instance set to NULL at block 1808. At block 1810, a recursive loop navigation of the tree begins where the temporary memory examined to see if there are any children components relative to the currently indexed location in the loop. If there is a child component listed, a look-up is performed to confirm that the component is registered and, upon confirmation, instance manager 206 establishes an instance data object for the component at block 1812. A logic node object is created which invokes the component-type method as prescribed in the script file to set this new instance of a component to the tree at block 1814. Process 1800 loops back to block 1810 where the temporary memory is examined for additional child components in the tree. If there are no more child components listed and all components of the tree have been navigated, then the temporary memory is destroyed and the script load process concludes at block 1816 by displaying the component tree on canvas 302 of GUI 202.

Whether a user is starting a new script or manipulating a previously saved script, components are added and removed from the component tree by creating new instance data objects and logic node data objects, or destroying existing instance data objects and logic node data objects of instance manager 206, respectively.

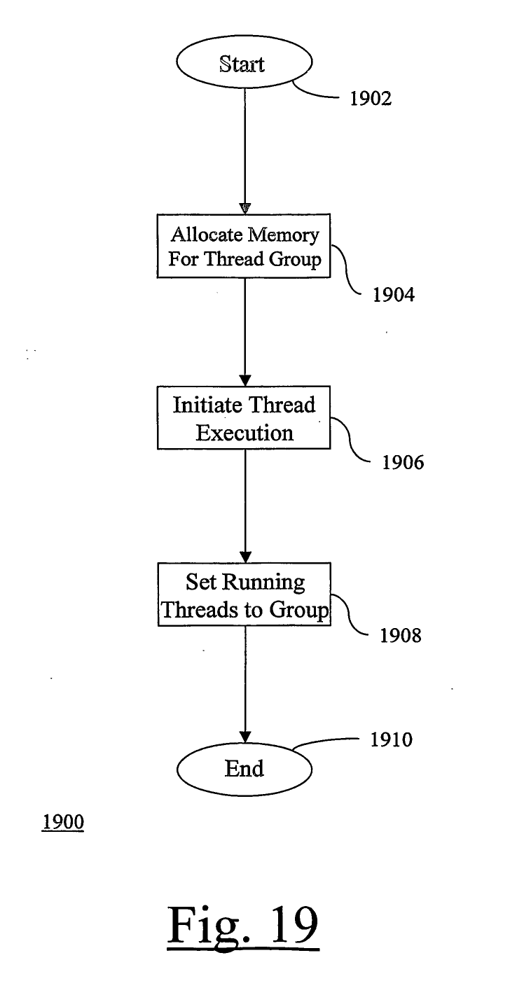

A feature of the present invention is the capacity to add or delete an instance of a component in the component tree while a script is running. Recompilation is not required. FIG. 19 shows a flow chart of a run process 1900 for running a script.

Process 1900 begins at block 1902 when a user chooses to run the currently loaded script. Proceeding to block 1904, development environment 200 allocates memory for a thread group, which is a set of threads that may be manipulated all at once rather than individually. At block 1906, development environment 200 initiates thread execution for the collection of command methods in the component tree as managed by instance manager 206. As noted earlier, command methods denote action within the component structure. Therefore, the command methods determine instantiation or termination of any running thread. Any subsequent component actions defined by the script occur within these threads of execution. At block 1908, the thread group target is set to the currently running threads. The process for running a script ends at block 1910, when either a user chooses to terminate the running script, or until each running thread stops by completion. If a user decides to terminate the running script, development environment 200 terminates the thread group and all running threads within the group are destroyed.

Components can be set or unset from a running script without having to stop and recompile. Development environment 200 uses a public interface comprising set and unset methods implemented by each component wrapper 1404 for appropriately setting and unsetting that particular component from a running script.

4. Deployment Manager 208

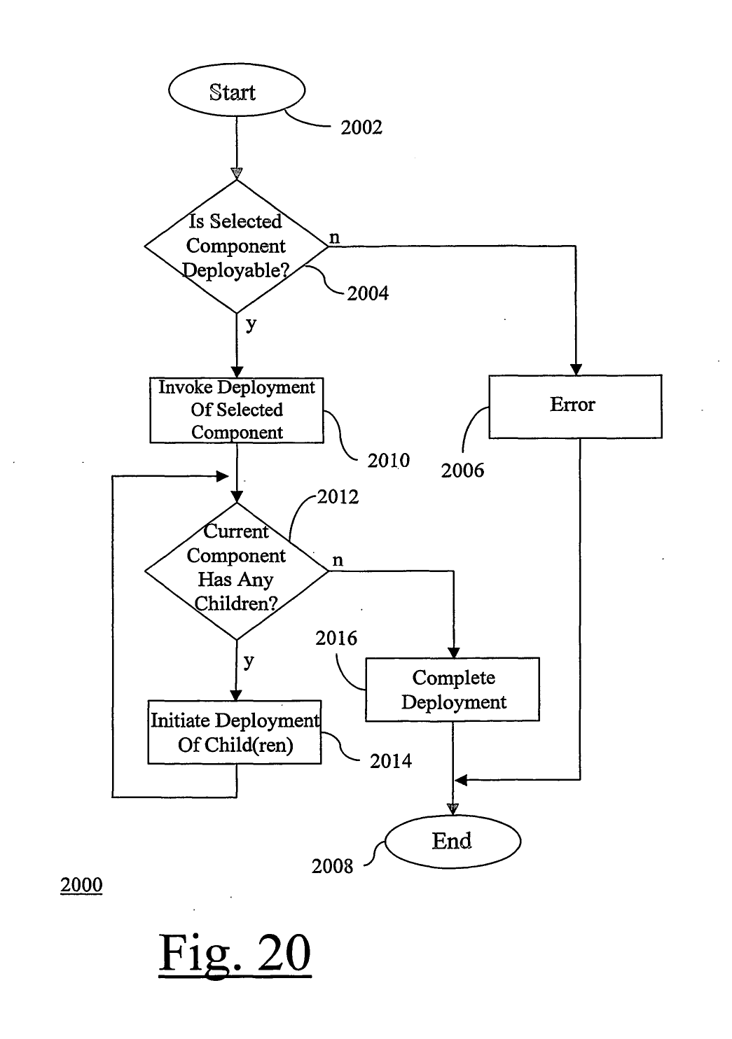

A unique and novel feature of the present invention is the one-click deployment process to deploy the script to an executable component-based architecture. The novelty of the process is that a deployable interface is called by development environment 200, but the interface is implemented by individual deployable components, using build functions proprietary to each component, thereby establishing modularity and independence among what may be necessarily unique deployment procedures. Deployment is dependent on the components themselves, and not on development environment 200. FIG. 20 shows a one-click deployment process 2000 managed by deployment manager 208.

Process 2000 begins at block 2002, when a user actuates the build and deploy process after selecting a component in the component tree for deployment. Proceeding to block 2004, development environment 200 verifies that the selected instance is deployable. The selected component is deployable if the associated component wrapper implements a public deployable interface of development environment 200. In this manner, each component 1404 is responsible for deploying itself. If the selected component is not deployable, an error is indicated to the user at block 2006 and deployment process 2000 concludes at block 2008. However, if the selected component is deployable, development environment 200 invokes the deployment method encapsulated in the component wrapper at block 2010. In cascading fashion, each component is responsible for calling the deployment method of the components at the next lower hierarchal level in the component tree, as well as passing any parameters thereto required for deployment. Hence, a child component deploys differently depending on its parent component. At decision block 2012, the deploying component is examined for one or more child components. If the deploying component has one or more child components in the tree, then deployment is initiated on the child(ren) component(s) at block 2014, which includes invoking the deployment method encapsulated in the child(ren)'s component wrapper(s). Blocks 2012 and 2014 may be called recursively, until the lowermost child component in the component tree is reached. Once it is determined that there are no longer any children in the tree at block 2012, each component runs its deployment function to completion at block 2016, successively working back up the tree to the original, selected deployable component. In this manner, any parent component does not fully deploy until all child components on a lower hierarchal level are deployed. This could easily be achieved using a recursive method call, however there are alternative means as well. After all instances are deployed, deployment process 2000 ends at block 2008.

Because each component is responsible for deploying itself, development environment 200 can deploy any type of component. For example, an Application component may deploy by building and compiling a “Main” file. In contrast, a SeivletScript component may deploy by building and compiling a servlet class. Development environment 200 can handle either situation, since each component wrapper implements the logic for building and deploying the final product interconnecting the associated component binaries.

In one embodiment of the invention, development environment 200 may have an embedded webserver for sharing or receiving components with other users. The webserver is connected to a network such as a local area network, or a global network such as the Internet.

In a peer-to-peer network setting, each user of development environment 200 has a local repository of components comprising the component binaries, the associated component wrappers, and the associated interface definition files. A user can publish the repository to the network, which allows other users to pull the components from the network for use.

Each user's published repository preferably has a component registration file which lists the components available therein. When a user connects development environment 200 to the network, development environment 200 searches the network for published component registration files. These published component registration files are used in the same manner as the local component registration file by development environment 200. In this manner, development environment 200 registers the components of published repositories on the network. Information on the components is easily shared using the interface definition file, which is preferably in a structured markup language such as XML. A user of development environment 200 may build scripts as already described herein, having these additional, shared components now available.

When a script is run or deployed, development environment 200 ensures that all required resources are present. If any of the resources are not available, development environment 200 searches the network for the required resources and, if found, pulls them from the network to the local repository.

In an alternative embodiment, a “logic-hub” can be employed that incorporates a central server that hosts a published repository of components. A development environment 200 may pull the shared components from the published repository for use in building or manipulating a script.

In still yet another alternative embodiment, a work group can collaboratively work with a central server holding a script. The work group can collaboratively build and modify a script on the central server, posting updates thereto.

While this invention has been described in conjunction with specific embodiments thereof, it is evident that many alternatives, modifications and variations will be apparent to those skilled in the art. Accordingly, the preferred embodiments of the invention as set forth herein, are intended to be illustrative, not limiting. Various changes may be made without departing from the true spirit and full scope of the invention as set forth herein and defined in the claims.

1. A computer program embodied on a computer-readable medium providing a development environment for creating a component-based architecture, the computer program comprising:
first software configured to register one or more software components in accordance with an interface definition file associated with each component, each interface definition file being based on a structured markup language identifying one or more methods invocable by the associated component;
second software configured to generate a graphical interface so as to enable a user to build a component-based script in a hierarchal tree format using the components, the hierarchal tree format comprising a plurality of hierarchal levels, wherein at least one instance of a component of a first level is configured to interact with at least one component of a second level as defined by the one or more methods;
third software configured to manage a data structure which organizes the components and the one or more methods of the script; and,
fourth software configured to deploy the script to a component-based architecture.

2. The computer program of claim 1, wherein the first software performs the steps of:
parsing the interface definition file, each interface definition file comprising an interface definition, and
storing the interface definition into a memory module.

3. The computer program of claim 1, wherein the fourth software deploys the script using a deployable interface individually implemented by the one or more components.

4. The computer program of claim 1, further comprising:
fifth software configured for exchanging components over a network.

5. The computer program of claim 4, wherein the network is a global network.

6. The computer program of claim 4, wherein the fifth software is a webserver.

7. The computer program of claim 4, wherein the network is a peer-to-peer network.

8. A computer-implemented method providing a visualization of a component-based architecture development environment comprising the step of:
generating a display of a component-based script in a hierarchal-tree format comprising one or more hierarchal levels, each level comprising at least one component wherein a relationship between the at least one component of a first hierarchal level and the at least one component of a second hierarchal level is visually represented as being defined by a method.

9. The computer-implemented method of claim 8, wherein the display comprises a canvas for displaying the script, and an interacts window for displaying the one or more methods available for defining the relationship between the components of the script.

10. The computer-implemented method of claim 9, wherein the interacts window further displays one or more components that may be passed as a parameter to the one or more method selections.

11. The computer-implemented method of claim 8, wherein portions of the script may be toggled between a hidden state and a revealed state.

12. The computer-implemented method of claim 8, wherein the display of the script may be expanded or collapsed in real time enabling an unlimited number of intermediate positions.

13. The computer-implemented method of claim 8, wherein the one or more components are displayed connected to the method by connect-bars.

14. A software component framework including one or more components, each component comprising:
a component binary comprising an implementation portion of the component framework,
a component wrapper comprising an interface portion of the component framework enabling the component binary to interface with a development environment, and
an interface definition file comprising an interface definition portion of the component framework that enables the component wrapper to register with the development environment.

15. The software component framework of claim 14, wherein the component binary is a compiled object class.

16. The software component framework of claim 14, wherein the interface definition file comprises a description schema in a structured markup language.

17. The software component framework of claim 16, wherein the structured markup language is extensible Markup Language (XML).

18. The software component framework of claim 14, wherein the interface definition file comprises a meta section, an interface section, and a component-tree section.

19. The software component framework of claim 14, wherein the interface definition file identifies one or more classes of which the component wrapper is an inheriting subclass.

20. The software component framework of claim 18, wherein the interface section comprises one or more method sections each identifying a method encapsulated in the component wrapper, the one or more methods being an attachment point to the component wrapper.

21. The software component framework of claim 20, wherein each method section further identifies an object type passed to the method at invocation.

22. The software component framework of claim 14, wherein if the one or more components is deployable, the one or more components has an individual build method for a deployment process.

23. The software component framework of claim 14, wherein the one or more components is shared over a network.

24. The software component framework of claim 20, wherein the one or more methods is of a component method-type that sets a new component to a component script.

25. The software component framework of claim 20, wherein the one or more methods is of a property method-type that sets a value to a property defining a component.

26. The software component framework of claim 20, wherein the one or more methods is of a command method-type that denotes action within the component.

27. The software component framework of claim 25, wherein the property method-type sets the value to the property from either a link component whose value is set dynamically or a link-constant component whose value is set statically.

28. A computer system for providing a development environment for creating a component-based architecture, the system comprising:
a processor for registering one or more software components in accordance with an interface definition file associated with each component, each interface definition file being based on a structured markup language identifying one or more methods invocable by the associated component;
a display for displaying a graphical interface so as to enable a user to build a component-based script in a hierarchal tree format using the components, the hierarchal tree format comprising a plurality of hierarchal levels, wherein at least one component of a first level is configured to interact with at least one component of a second level as defined by the one or more methods;
a memory module for holding a data structure which organizes the components and the one or more methods of the script.

29. The computer system of claim 28, wherein the processor deploys the script to a component-based architecture.

30. The computer system of claim 28, wherein the processor performs the steps of:
parsing the interface definition file, each interface definition file comprising an interface definition, and
storing the interface definition into the memory module.

31. The computer system of claim 29, wherein the processor deploys the script using a deployable interface individually implemented by the one or more components.

32. The computer system of claim 28, further comprising a communications interface for exchanging components over a network.

33. The computer system of claim 32, wherein the network is a global network.

34. The computer program of claim 32, wherein the network is a peer-to-peer network.
